(19) United States
(12) Patent Application Publication
(10) Pub. No.: US 2026/0184218 A1
(43) Pub. Date: Jul. 2, 2026

(54) CHARGE AND DISCHARGE CONTROL METHOD AND CIRCUIT AND INTEGRATED CHARGING AND DISCHARGING GUN

(71) Applicant: Luxshare Precision Industry (Jiangsu)Co.,Ltd., Liyang (CN)

(72) Inventors: Longlong Peng, Liyang (CN); Xuerui SUN, Liyang (CN); Ming ZHOU, Liyang (CN); Wanli YU, Liyang (CN)

(73) Assignee: Luxshare Precision Industry (Jiangsu)Co.,Ltd., Liyang (CN)

(21) Appl. No.: 19/276,739

(22) Filed: Jul. 22, 2025

(30) Foreign Application Priority Data
Dec. 26, 2024 (CN) 202411942777.X

(51) Int. Cl. B60L 53/62; B60L 53/16

(52) U.S. Cl. CPC B60L 53/62; B60L 53/16

(57) ABSTRACT

A charge and discharge control method, performed by a processor in a charge and discharge control circuit, includes in response to the existence of the voltage signal between the L1 terminal of the first interface module and the N/L2 terminal of the first interface module and the absence of voltage signal between the L1 terminal of the second interface module and the N/L2 terminal of the second interface module, controlling the vehicle to enter a charging mode; and in response to the absence of the voltage signal between the L1 terminal of the first interface module and the N/L2 terminal of the first interface module and the existence of the voltage signal between the L1 terminal of the second interface module and the N/L2 terminal of the second interface module, controlling the vehicle to enter a discharge mode.

### CROSS-REFERENCE TO RELATED APPLICATION(S)

This application claims priority to Chinese Patent Application No. 202411942777.X filed Dec. 26, 2024, the disclosure of which is incorporated herein by reference in its entirety.

### TECHNICAL FIELD

Embodiments of the present disclosure relate to charge and discharge control technology and, for example, to a charge and discharge control method, a charge and discharge control circuit, and an integrated charging and discharging gun.

### BACKGROUND

With the development of new energy technology, new energy vehicles have increasingly wide applications. The new energy vehicles can be charged or discharged through an integrated charging and discharging gun. However, the existing integrated charging and discharging gun cannot be compatible with various charging and discharge modes when performing charge and discharge control.

### SUMMARY

Embodiments of the present disclosure provide a charge and discharge control method, a charge and discharge control circuit, and an integrated charging and discharging gun, so as to achieve compatibility with various charging and discharge modes.

In a first aspect, embodiments of the present disclosure provide a charge and discharge control method. The charge and discharge control method is performed by a processor in a charge and discharge control circuit, where the charge and discharge control circuit includes a first interface module, a switch module, a second interface module, and the processor.

An L1 terminal of the first interface module is connected to an L1 terminal of the second interface module through the switch module; an N/L2 terminal of the first interface module is connected to an N/L2 terminal of the second interface module through the switch module; and the switch module is configured to control the L1 terminal of the first interface module and the N/L2 terminal of the first interface module to be connected to or disconnected from the L1 terminal of the second interface module and the N/L2 terminal of the second interface module, respectively.

The second interface module is configured to be electrically connected to a vehicle, the first interface module, the switch module, and the second interface module are all electrically connected to the processor, and the first interface module is configured to be connected to a load or a power supply.

The charge and discharge control method includes the steps below.

A voltage signal between the L1 terminal of the first interface module and the N/L2 terminal of the first interface module and a voltage signal between the L1 terminal of the second interface module and the N/L2 terminal of the second interface module are detected.

In response to existence of the voltage signal between the L1 terminal of the first interface module and the N/L2 terminal of the first interface module and absence of the voltage signal between the L1 terminal of the second interface module and the N/L2 terminal of the second interface module, the vehicle is controlled to enter a charging mode.

In response to absence of the voltage signal between the L1 terminal of the first interface module and the N/L2 terminal of the first interface module and existence of the voltage signal between the L1 terminal of the second interface module and the N/L2 terminal of the second interface module, the vehicle is controlled to enter a discharge mode.

Optionally, the charge and discharge control circuit further includes a state switching module, the state switching module includes a first identification resistor unit adapted to the charging mode, a second identification resistor unit adapted to the discharge mode, and a first switch, and the first switch is configured to control the first identification resistor unit or the second identification resistor unit to be electrically connected to the second interface module.

That the vehicle is controlled to enter the charging mode includes the steps below.

In response to the existence of the voltage signal between the L1 terminal of the first interface module and the N/L2 terminal of the first interface module and the existence of the voltage signal between the L1 terminal of the second interface module and the N/L2 terminal of the second interface module, a state of the first switch is controlled such that the first identification resistor unit is connected to the second interface module.

The voltage signal between the L1 terminal of the first interface module and the N/L2 terminal of the first interface module and the voltage signal between the L1 terminal of the second interface module and the N/L2 terminal of the second interface module are re-detected.

In response to the existence of the voltage signal between the L1 terminal of the first interface module and the N/L2 terminal of the first interface module and the absence of the voltage signal between the L1 terminal of the second interface module and the N/L2 terminal of the second interface module, the vehicle is controlled to enter the charging mode.

Optionally, before the voltage signal between the L1 terminal of the first interface module and the N/L2 terminal of the first interface module and the voltage signal between the L1 terminal of the second interface module and the N/L2 terminal of the second interface module are detected, the following step is included.

An initial state is set, where the initial state includes that the L1 terminal of the first interface module and the N/L2 terminal of the first interface module are disconnected from the L1 terminal of the second interface module and the N/L2 terminal of the second interface module and that the second identification resistor unit is connected to the second interface module.

Optionally, the load includes a vehicle load and a non-vehicle load, the non-vehicle load is electrically connected to the first interface module through a strip, and the vehicle load is electrically connected to the first interface module through an accessory charging gun, where the strip includes a first voltage divider identification resistor.

The charge and discharge control circuit further includes a type detection module configured to output an analog-to-digital (AD) value according to the first voltage divider identification resistor.

That the vehicle is controlled to enter the discharge mode includes the steps below.

The AD value output from the type detection module is acquired, and whether the first interface module is connected to the vehicle load or the non-vehicle load is determined according to the AD value.

In response to the first interface module being connected to the vehicle load, the vehicle is controlled to enter a vehicle load discharge mode.

In response to the first interface module being connected to the non-vehicle load, the vehicle is controlled to enter a non-vehicle load discharge mode.

The L1 terminal of the first interface module and the N/L2 terminal of the first interface module are controlled to be connected to the L1 terminal of the second interface module and the N/L2 terminal of the second interface module, respectively.

Optionally, the load includes a vehicle load and a non-vehicle load, the non-vehicle load is electrically connected to the first interface module through a strip, and the vehicle load is electrically connected to the first interface module through an accessory charging gun, where the strip includes a temperature sensing integrated circuit (IC).

The charge and discharge control circuit further includes a type detection module configured to acquire digital information output from the temperature sensing IC.

That the vehicle is controlled to enter the discharge mode includes the steps below.

The digital information output from the temperature sensing IC is acquired, and whether the first interface module is connected to the vehicle load or the non-vehicle load is determined according to the digital information.

In response to the first interface module being connected to the vehicle load, the vehicle is controlled to enter a vehicle load discharge mode.

In response to the first interface module being connected to the non-vehicle load, the vehicle is controlled to enter a non-vehicle load discharge mode.

The L1 terminal of the first interface module and the N/L2 terminal of the first interface module are controlled to be connected to the L1 terminal of the second interface module and the N/L2 terminal of the second interface module, respectively.

Optionally, that the vehicle is controlled to enter the vehicle load discharge mode includes the steps below.

Whether a second pulse-width modulation (PWM) signal exists at a signal terminal of the second interface module is detected.

In response to the second PWM signal at the signal terminal of the second interface module, a second target PWM signal is output to the vehicle load according to the second PWM signal.

Optionally, the power supply includes a charging pile or a power grid.

That the vehicle is controlled to enter the charging mode includes the steps below.

Whether a first PWM signal exists at a signal terminal of the first interface module is detected.

In response to the first PWM signal at the signal terminal of the first interface module, the vehicle is controlled to enter a charging pile charging mode.

In response to no first PWM signal at the signal terminal of the first interface module, the vehicle is controlled to enter a power grid charging mode.

Optionally, the charge and discharge control circuit further includes a first signal detection module, the first signal detection module includes a first field-effect transistor, a gate of the first field-effect transistor is configured to receive a voltage signal from the signal terminal of the first interface module, a drain of the first field-effect transistor is electrically connected to the processor through a first resistor, a power supply voltage is input into the drain of the first field-effect transistor through a pull-up resistor, and a source of the first field-effect transistor is grounded.

That the vehicle is controlled to enter the charging pile charging mode includes the steps below.

A duty cycle of the first PWM signal and a frequency of the first PWM signal are acquired through the first signal detection module.

A first target PWM signal is output to the vehicle according to the duty cycle of the first PWM signal and the frequency of the first PWM signal.

Optionally, the first interface module is configured to be connected to the power grid through a power plug, and that the vehicle is controlled to enter the power grid charging mode includes the steps below.

A type of the power plug is identified and a capacity of the power plug is detected.

A third target PWM signal is output to the vehicle according to the capacity of the power plug.

In a second aspect, embodiments of the present disclosure provide a charge and discharge control circuit including a first interface module, a switch module, a second interface module, and a processor; where an L1 terminal of the first interface module is connected to an L1 terminal of the second interface module through the switch module; an N/L2 terminal of the first interface module is connected to an N/L2 terminal of the second interface module through the switch module; the switch module is configured to control the L1 terminal of the first interface module and the N/L2 terminal of the first interface module to be connected to or disconnected from the L1 terminal of the second interface module and the N/L2 terminal of the second interface module, respectively; and the second interface module is configured to be electrically connected to a vehicle, the first interface module, the switch module, and the second interface module are all electrically connected to the processor, and the first interface module is configured to be connected to a load or a power supply.

Optionally, the charge and discharge control circuit further includes a state switching module, the state switching module includes a first identification resistor unit adapted to a charging mode, a second identification resistor unit adapted to a discharge mode, and a first switch, and the first switch is configured to control the first identification resistor unit or the second identification resistor unit to be electrically connected to the second interface module.

Optionally, the charge and discharge control circuit further includes a first signal detection module, the first signal detection module includes a first field-effect transistor, a gate of the first field-effect transistor is configured to receive a voltage signal from a signal terminal of the first interface module, a drain of the first field-effect transistor is electrically connected to the processor through a first resistor, a power supply voltage is input into the drain of the first field-effect transistor through a pull-up resistor, and a source of the first field-effect transistor is grounded.

Optionally, the charge and discharge control circuit further includes a type detection module, the type detection module includes a second resistor, a power supply voltage is input into one terminal of the second resistor, and the other terminal of the second resistor is electrically connected to a signal terminal of the first interface module.

When the first interface module is connected to the load or the power supply, the first interface module is electrically connected to the load or the power supply through an accessory, the accessory includes at least one of a power plug, a strip, and an accessory charging gun, at least one of the power plug and the strip is provided with a voltage divider identification resistor, one terminal of the voltage divider identification resistor is electrically connected to the signal terminal of the first interface module, and the other terminal of the voltage divider identification resistor is grounded.

The processor is configured to acquire an AD value at the signal terminal of the first interface module.

Optionally, the charge and discharge control circuit further includes a type detection module, the type detection module includes a Zener diode, a clamping diode, a fourth resistor, and a filtering capacitor; and a positive electrode of the Zener diode is grounded, a negative electrode of the Zener diode is electrically connected to a signal terminal of the first interface module, the negative electrode of the Zener diode is electrically connected to a first terminal of the clamping diode through the fourth resistor, a second terminal of the clamping diode is grounded, a power supply voltage is input into a third terminal of the clamping diode, the third terminal of the clamping diode is grounded through the filtering capacitor, and the third terminal of the clamping diode is electrically connected to the first terminal of the clamping diode through a fifth resistor.

When the first interface module is connected to the load or the power supply, the first interface module is electrically connected to the load or the power supply through an accessory, the accessory includes at least one of a power plug, a strip, and an accessory charging gun, at least one of the power plug and the strip is provided with a temperature sensing IC, and the temperature sensing IC is electrically connected to the signal terminal of the first interface module.

The processor is configured to acquire digital information at the signal terminal of the first interface module.

Optionally, the charge and discharge control circuit further includes a signal generation module, the signal generation module includes a first triode, a second triode, a third triode, and a fourth triode, a power supply voltage is input into a base of the first triode, a collector of the first triode is electrically connected to a base of the third triode, an emitter of the first triode and an emitter of the second triode are connected to different ports of the processor, a base of the second triode is grounded, a collector of the second triode is electrically connected to a base of the fourth triode, a second voltage is input into an emitter of the fourth triode, a collector of the fourth triode is electrically connected to a collector of the third triode, the collector of the fourth triode is electrically connected to a signal terminal of the first interface module or a control pilot terminal of the second interface module when the signal generation module is in operation, and a first voltage is input into an emitter of the third triode.

In a third aspect, embodiments of the present disclosure provide an integrated charging and discharging gun including a vehicle-end charging and discharging gun body and an accessory, where the vehicle-end charging and discharging gun body includes the charge and discharge control circuit as described in the second aspect; and the accessory is adapted to the first interface module, and the accessory includes at least one of a power plug, a strip, and an accessory charging gun.

### BRIEF DESCRIPTION OF DRAWINGS

FIG. 1 is a flowchart of a charge and discharge control method according to embodiment one of the present disclosure.

FIG. 2 is a flowchart of a charge and discharge control method according to embodiment two of the present disclosure.

FIG. 3 is a flowchart of a charge control method according to embodiment two of the present disclosure.

FIG. 4 is a flowchart of a discharge control method according to embodiment two of the present disclosure.

FIG. 5 is a structural diagram of a charge and discharge control circuit according to embodiment three of the present disclosure.

FIG. 6 is a structural diagram of a state switching module according to embodiment three of the present disclosure.

FIG. 7 is a structural diagram of a first signal detection module according to embodiment three of the present disclosure.

FIG. 8 is a structural diagram of a second signal detection module according to embodiment three of the present disclosure.

FIG. 9 is a structural diagram of a driving supplement circuit according to embodiment three of the present disclosure.

FIG. 10 is a structural diagram of a type detection module according to embodiment three of the present disclosure.

FIG. 11 is a structural diagram of another type detection module according to embodiment three of the present disclosure.

FIG. 12 is a structural diagram of a signal generation module according to embodiment three of the present disclosure.

FIG. 13 is a partial structural diagram of an integrated charging and discharging gun according to embodiment three of the present disclosure.

### DETAILED DESCRIPTION

The present disclosure is described hereinafter in detail in conjunction with drawings and embodiments. It is to be understood that the embodiments described herein are intended to explain the present disclosure and not to limit the present disclosure. Additionally, it is to be noted that for ease of description, only part, not all, of the structures related to the present disclosure are illustrated in the drawings.

### Embodiment One

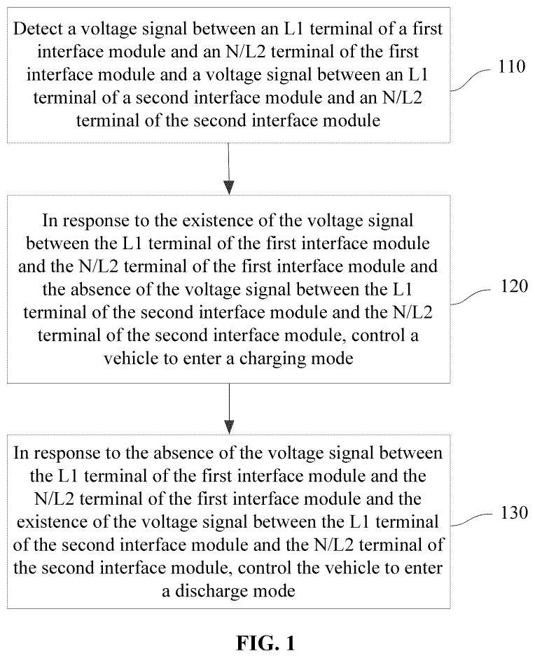

FIG. 1 is a flowchart of a charge and discharge control method according to embodiment one of the present disclosure. This embodiment is applicable to the charge and discharge control of a vehicle such as a new energy vehicle. The method may be performed by a processor in a charge and discharge control circuit, where the processor may be implemented by software and/or hardware. The charge and discharge control circuit includes a first interface module, a switch module, a second interface module, and the processor; an L1 terminal of the first interface module is connected to an L1 terminal of the second interface module through the switch module; an N/L2 terminal of the first interface module is connected to an N/L2 terminal of the second interface module through the switch module; the switch module is configured to control the L1 terminal of the first interface module and the N/L2 terminal of the first interface module to be connected to or disconnected from the L1 terminal of the second interface module and the N/L2 terminal of the second interface module, respectively; and the second interface module is configured to be electrically connected to a vehicle, the first interface module, the switch module, and the second interface module are all electrically connected to the processor, and the first interface module is configured to be connected to a load or a power supply. The charge and discharge control method specifically includes the steps below.

In step 110, a voltage signal between the L1 terminal of the first interface module and the N/L2 terminal of the first interface module and a voltage signal between the L1 terminal of the second interface module and the N/L2 terminal of the second interface module are detected.

In step 120, in response to the existence of the voltage signal between the L1 terminal of the first interface module and the N/L2 terminal of the first interface module and the absence of the voltage signal between the L1 terminal of the second interface module and the N/L2 terminal of the second interface module, the vehicle is controlled to enter a charging mode.

For example, the power supply includes a charging pile or a power grid, and that the vehicle enters the charging mode means that the vehicle enters a charging pile charging mode or that the vehicle enters a power grid charging mode. After the vehicle enters the charging mode, the switch module is controlled to be turned on so that the L1 terminal of the first interface module is connected to the L1 terminal of the second interface module, and the N/L2 terminal of the first interface module is connected to the N/L2 terminal of the second interface module through the switch module, thereby charging the vehicle.

In step 130, in response to the absence of the voltage signal between the L1 terminal of the first interface module and the N/L2 terminal of the first interface module and the existence of the voltage signal between the L1 terminal of the second interface module and the N/L2 terminal of the second interface module, the vehicle is controlled to enter a discharge mode.

For example, the load includes a vehicle load or a non-vehicle load, the vehicle load may be a new energy vehicle, and the non-vehicle load is a load other than the vehicle load, such as a kettle, an induction cooker, or a mobile phone. That the vehicle enters the discharge mode means that the vehicle enters a vehicle load discharge mode or that the vehicle enters a non-vehicle load discharge mode. After the vehicle enters the discharge mode, the switch module is controlled to be turned on so that the L1 terminal of the first interface module is connected to the L1 terminal of the second interface module, and the N/L2 terminal of the first interface module is connected to the N/L2 terminal of the second interface module through the switch module, thereby discharging the vehicle.

According to the charge and discharge control method of this embodiment, whether the vehicle is connected to the power supply or the load may be determined according to the voltage signal between the L1 terminal of the first interface module and the N/L2 terminal of the first interface module and the voltage signal between the L1 terminal of the second interface module and the N/L2 terminal of the second interface module, and then the vehicle is controlled to enter the charging mode or the discharge mode so that the power supply such as the charging pile or the power grid charges the vehicle through the charge and discharge control circuit, or the vehicle supplies power to the load such as the vehicle load or the non-vehicle load through the charge and discharge control circuit, thereby achieving compatibility with various charging and discharge modes.

### Embodiment Two

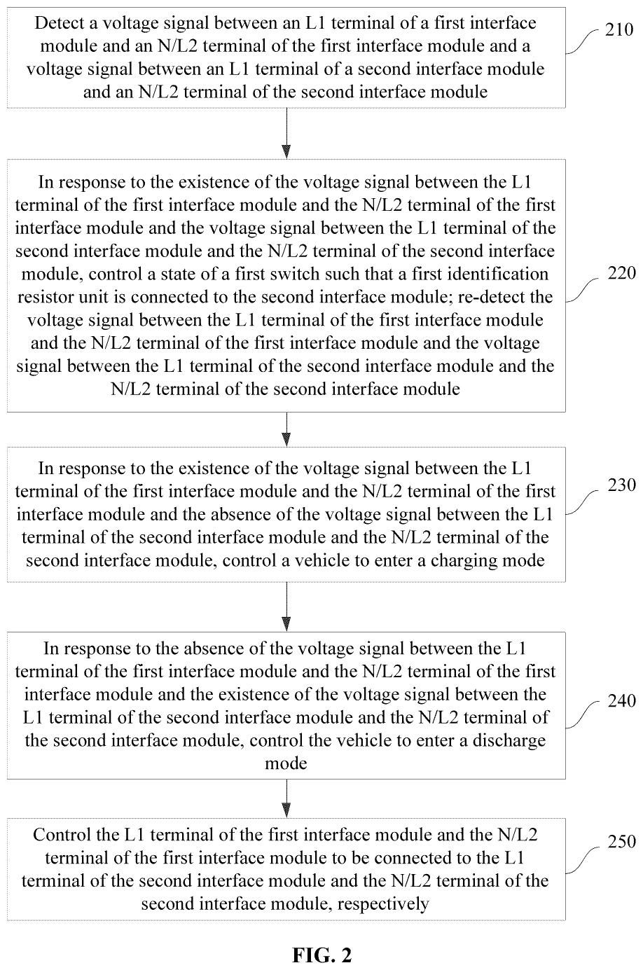

FIG. 2 is a flowchart of a charge and discharge control method according to embodiment two of the present disclosure. This embodiment is applicable to the charge and discharge control of a vehicle such as a new energy vehicle. The method may be performed by a processor in a charge and discharge control circuit, where the processor may be implemented by software and/or hardware. The charge and discharge control circuit includes a first interface module, a switch module, a second interface module, and the processor; an L1 terminal of the first interface module is connected to an L1 terminal of the second interface module through the switch module; an N/L2 terminal of the first interface module is connected to an N/L2 terminal of the second interface module through the switch module; the switch module is configured to control the L1 terminal of the first interface module and the N/L2 terminal of the first interface module to be connected to or disconnected from the L1 terminal of the second interface module and the N/L2 terminal of the second interface module, respectively; and the second interface module is configured to be electrically connected to a vehicle, the first interface module, the switch module, and the second interface module are all electrically connected to the processor, and the first interface module is configured to be connected to a load or a power supply. The charge and discharge control circuit further includes a state switching module, the state switching module includes a first identification resistor unit adapted to a charging mode, a second identification resistor unit adapted to a discharge mode, and a first switch, and the first switch is configured to control the first identification resistor unit or the second identification resistor unit to be electrically connected to the second interface module. The charge and discharge control method specifically includes the steps below.

In step 210, a voltage signal between the L1 terminal of the first interface module and the N/L2 terminal of the first interface module and a voltage signal between the L1 terminal of the second interface module and the N/L2 terminal of the second interface module are detected.

The voltage signal between the L1 terminal of the first interface module and the N/L2 terminal of the first interface module and the voltage signal between the L1 terminal of the second interface module and the N/L2 terminal of the second interface module are both alternating current voltage signals. Additionally, before the voltage signal between the L1terminal of the first interface module and the N/L2 terminal of the first interface module and the voltage signal between the L1 terminal of the second interface module and the N/L2 terminal of the second interface module are detected, an initial state may be set, where the initial state includes that the L1 terminal of the first interface module and the N/L2 terminal of the first interface module are disconnected from the L1 terminal of the second interface module and the N/L2 terminal of the second interface module and that the second identification resistor unit is connected to the second interface module.

Further, the power supply includes a charging pile or a power grid, the first interface module is connected to the power grid through a power plug, and the first interface module is connected to the charging pile through an accessory charging gun. The load includes a vehicle load and a non-vehicle load; the non-vehicle load is electrically connected to the first interface module through a strip; and the vehicle load is electrically connected to the first interface module through the accessory charging gun, where the strip includes a first voltage divider identification resistor. The charge and discharge control circuit further includes a type detection module configured to output an AD value according to the first voltage divider identification resistor. The charge and discharge control circuit further includes a first signal detection module, the first signal detection module includes a first field-effect transistor, a gate of the first field-effect transistor is configured to receive a voltage signal from a signal terminal of the first interface module, a drain of the first field-effect transistor is electrically connected to the processor through a first resistor, a power supply voltage is input into the drain of the first field-effect transistor through a pull-up resistor, and a source of the first field-effect transistor is grounded.

In step 220, in response to the existence of the voltage signal between the L1 terminal of the first interface module and the N/L2 terminal of the first interface module and the voltage signal between the L1 terminal of the second interface module and the N/L2 terminal of the second interface module, a state of the first switch is controlled such that the first identification resistor unit is connected to the second interface module; and the voltage signal between the L1terminal of the first interface module and the N/L2 terminal of the first interface module and the voltage signal between the L1 terminal of the second interface module and the N/L2 terminal of the second interface module are re-detected, that is, step 210 is re-performed.

Specifically, the first switch is electrically connected to the processor, and the processor controls the first switch to make the first identification resistor unit or the second identification resistor unit connected to the second interface module. In response to the existence of the voltage signal between the L1 terminal of the first interface module and the N/L2 terminal of the first interface module and the voltage signal between the L1 terminal of the second interface module and the N/L2 terminal of the second interface module, the processor controls the first switch to make the first identification resistor unit connected to the second interface module.

In this embodiment, in the initial state, the second identification resistor unit is connected to the second interface module, and the vehicle is adapted to the discharge mode. Therefore, the voltage signal exists between the L1 terminal of the second interface module and the N/L2 terminal of the second interface module. If the voltage signal exists between the L1 terminal of the first interface module and the N/L2 terminal of the first interface module at the same time, that is, it is possible that the first interface module is connected to the power supply, the first identification resistor unit needs to be controlled to be connected to the second interface module (in this case, the vehicle is adapted to the charging mode), and the voltage signal between the L1 terminal of the first interface module and the N/L2 terminal of the first interface module and the voltage signal between the L1 terminal of the second interface module and the N/L2 terminal of the second interface module are re-detected. If it is re-detected that the voltage signal exists between the L1 terminal of the first interface module and the N/L2 terminal of the first interface module and the voltage signal exists between the L1 terminal of the second interface module and the N/L2 terminal of the second interface module, an abnormality exists, for example, the vehicle is abnormal or the switch module is abnormal, where the switch module includes a relay switch, and the relay switch may be stuck. Therefore, corresponding abnormality handling needs to be performed, and abnormality handling-related programs are not limited in this embodiment.

In step 230, in response to the existence of the voltage signal between the L1 terminal of the first interface module and the N/L2 terminal of the first interface module and the absence of the voltage signal between the L1 terminal of the second interface module and the N/L2 terminal of the second interface module, the vehicle is controlled to enter the charging mode.

FIG. 3 is a flowchart of a charge control method according to embodiment two of the present disclosure. Referring to FIG. 3, that the vehicle is controlled to enter the charging mode includes the steps below.

In step 231, whether a first PWM signal exists at the signal terminal of the first interface module is detected, where the first PWM signal is a PWM signal output from the charging pile.

In step 232, in response to the first PWM signal at the signal terminal of the first interface module, the vehicle is controlled to enter a charging pile charging mode. Step 232 specifically includes the steps below.

A duty cycle of the first PWM signal and a frequency of the first PWM signal are acquired through the first signal detection module.

A first target PWM signal is output to the vehicle according to the duty cycle of the first PWM signal and the frequency of the first PWM signal.

The first target PWM signal may be a PWM signal matching the duty cycle of the first PWM signal and the frequency of the first PWM signal, and the first target PWM signal is used for communication with the vehicle. If the first PWM signal exists at the signal terminal of the first interface module, it indicates that the first interface module is connected to the charging pile. The duty cycle of the first PWM signal and the frequency of the first PWM signal may be acquired according to on and off states of the first field-effect transistor in the first signal detection module. For example, the duty cycle of the first PWM signal may be the ratio of an on time of the first field-effect transistor to a sum of on and off times of the first field-effect transistor.

In step 233, in response to no first PWM signal at the signal terminal of the first interface module, the vehicle is controlled to enter a power grid charging mode. Step 233 specifically includes the steps below.

A type of the power plug is identified and a capacity of the power plug is detected.

A third target PWM signal is output to the vehicle according to the capacity of the power plug, where the third target PWM signal is used for communication with the vehicle. A duty cycle of the third target PWM signal and a frequency of the third target PWM signal may be determined according to the capacity of the power plug, which is not limited here. If no first PWM signal exists at the signal terminal of the first interface module, it indicates that the first interface module is connected to the power grid such as a household grid. For example, the power plug includes a 10 A plug, a 16 A plug, or a 32 A industrial plug. A second voltage divider identification resistor may be provided in the power plug, and a corresponding AD value is detected through the type detection module so that the type of the power plug is determined and the capacity of the power plug is detected. A temperature sensing IC may be provided in the power plug, and digital information output from the corresponding temperature sensing IC is acquired through the type detection module so that the type of the power plug is determined.

In step 240, in response to the absence of the voltage signal between the L1 terminal of the first interface module and the N/L2 terminal of the first interface module and the existence of the voltage signal between the L1 terminal of the second interface module and the N/L2 terminal of the second interface module, the vehicle is controlled to enter the discharge mode.

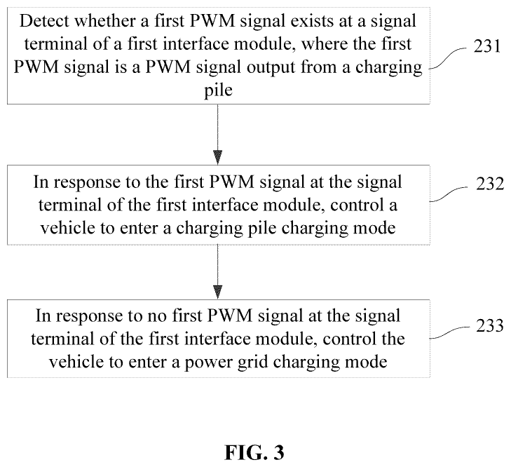

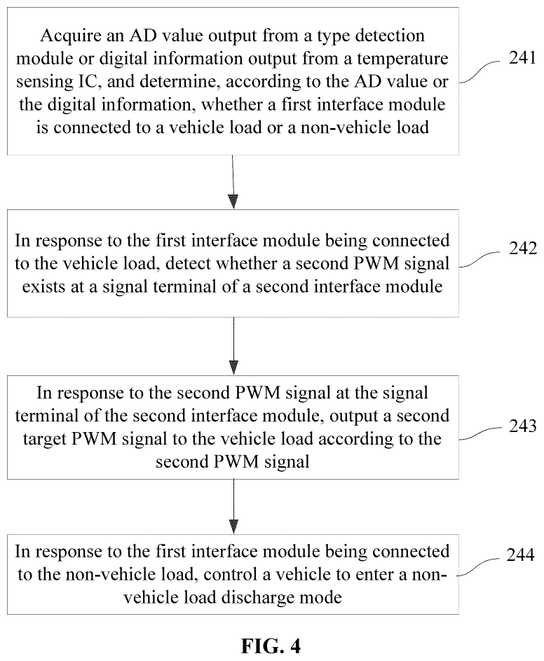

FIG. 4 is a flowchart of a discharge control method according to embodiment two of the present disclosure. Referring to FIG. 4, that the vehicle is controlled to enter the discharge mode includes the steps below.

In step 241, the AD value output from the type detection module or digital information output from a temperature sensing IC is acquired, and whether the first interface module is connected to the vehicle load or the non-vehicle load is determined according to the AD value or the digital information.

The digital information is a digital high or low level and includes information such as a serial number and a production date of the product. Different temperature sensing ICs output different digital information so that whether the first interface module is connected to the vehicle load or the non-vehicle load is determined. Moreover, if the AD value is within a preset range, it is determined that the first interface module is connected to the non-vehicle load; otherwise, the first interface module is connected to the vehicle load.

In step 242, in response to the first interface module being connected to the vehicle load, whether a second PWM signal exists at a signal terminal of the second interface module is detected.

The second PWM signal is a PWM signal output from the vehicle.

In step 243, in response to the second PWM signal at the signal terminal of the second interface module, a second target PWM signal is output to the vehicle load according to the second PWM signal.

The second target PWM signal may be a PWM signal matching the second PWM signal, and the second target PWM signal is used for the vehicle to communicate with the vehicle load.

In step 244, in response to the first interface module being connected to the non-vehicle load, the vehicle is controlled to enter a non-vehicle load discharge mode.

In step 250, the L1 terminal of the first interface module and the N/L2 terminal of the first interface module are controlled to be connected to the L1 terminal of the second interface module and the N/L2 terminal of the second interface module, respectively.

Specifically, the switch module is controlled to be turned on so that the L1 terminal of the first interface module and the N/L2 terminal of the first interface module are connected to the L1 terminal of the second interface module and the N/L2 terminal of the second interface module, and thus the vehicle is connected to the first interface module through the second interface module. When the first interface module is connected to the power supply, electrical energy may be transmitted from the power supply to the vehicle. When the first interface module is connected to the load, electrical energy may be transmitted from the vehicle to the load.

Additionally, before the L1 terminal of the first interface module and the N/L2 terminal of the first interface module are controlled to be connected to the L1 terminal of the second interface module and the N/L2 terminal of the second interface module, parameters such as voltage, current, current leakage, being grounded, and temperature may be confirmed. If each parameter does not exceed a set threshold corresponding to the parameter, the L1 terminal of the first interface module and the N/L2 terminal of the first interface module are controlled to be connected to the L1 terminal of the second interface module and the N/L2 terminal of the second interface module.

According to the charge and discharge control method of this embodiment, whether the first interface module is connected to the power supply or the load is determined according to the voltage signal between the L1 terminal of the first interface module and the N/L2 terminal of the first interface module and the voltage signal between the L1 terminal of the second interface module and the N/L2 terminal of the second interface module; whether the first PWM signal exists at the signal terminal of the first interface module is determined according to a signal at a signal terminal of the first signal detection module so that whether the power supply connected to the first interface module is the charging pile or the power grid is determined; whether the connected load is the vehicle load or the non-vehicle load may be determined according to a signal at the signal terminal of the first interface module and specifically by detecting the AD value at the signal terminal of the first interface module. Thus, the vehicle is controlled to enter the charging mode or the discharge mode, where the charging mode includes the charging pile charging mode or the power grid charging mode, and the discharge mode includes a vehicle load discharge mode or the non-vehicle load discharge mode, so that the vehicle is charged by the charging pile or the power grid, or the vehicle supplies power to the vehicle load or the non-vehicle load, thereby achieving compatibility with various charging and discharge modes.

### Embodiment Three

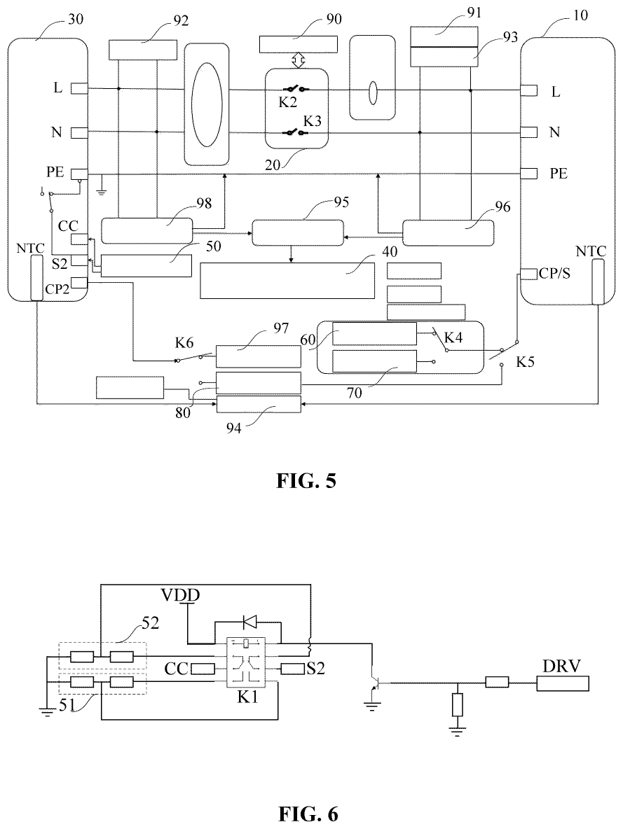

FIG. 5 is a structural diagram of a charge and discharge control circuit according to embodiment three of the present disclosure. Referring to FIG. 5, the charge and discharge control circuit includes a first interface module 10, a switch module 20, a second interface module 30, and a processor 40.

The second interface module 30 is a charging and discharging interface adapted to a vehicle and may adopt a five-hole charging and discharging interface or a seven-hole charging and discharging interface for charging and discharging of a new energy vehicle as long as corresponding functions can be implemented. In this embodiment, the seven-hole charging and discharging interface is used. The second interface module 30 includes an L1 terminal (an alternating current live terminal), an N/L2 terminal (an alternating current neutral terminal), a PE terminal (an alternating current ground terminal), a CC terminal (a charging connection confirmation terminal), a CP2 terminal (a control pilot terminal), an S2 terminal (a complete connection detection terminal), and an NTC terminal (a temperature information transmission terminal).

The first interface module 10 may adopt a five-hole connector or another connector for charging and discharging the new energy vehicle as long as the object of the present application can be achieved. The first interface module 10 is adapted to an accessory, and the first interface module 10 includes an L1 terminal (an alternating current live terminal), an N/L2 terminal (an alternating current neutral terminal), a PE terminal (an alternating current ground terminal), a CP/S terminal (a male terminal, that is, the signal terminal of the first interface module in any preceding embodiment), and an NTC terminal (a temperature information transmission terminal).

The accessory includes at least one of a power plug, a strip, and an accessory charging gun. In this embodiment, the first interface module 10 mates with the accessory through a male terminal and a female terminal.

The L1 terminal of the first interface module 10 is connected to the L1 terminal of the second interface module 30 through the switch module 20; the N/L2 terminal of the first interface module 10 is electrically connected to the N/L2 terminal of the second interface module 30 through the switch module 20; the switch module 20 is configured to control the L1 terminal of the first interface module 10 and the N/L2 terminal of the first interface module 10 to be connected to or disconnected from the L1 terminal of the second interface module 30 and the N/L2 terminal of the second interface module 30, respectively; and the second interface module 30 is configured to be electrically connected to the vehicle, the first interface module 10, the switch module 20, and the second interface module 30 are all electrically connected to the processor 40, and the first interface module 10 is configured to be connected to a load or a power supply.

The processor 40 is configured to perform charge and discharge control on the vehicle, including controlling an on or off state of the switch module 20 so that the L1 terminal of the first interface module 10 and the N/L2 terminal of the first interface module 10 are connected to or disconnected from the L1 terminal of the second interface module 30 and the N/L2 terminal of the second interface module 30. For a specific control process of the processor 40 performing the charge and discharge control on the vehicle, reference may be made to any preceding embodiment, and the details are not repeated here.

Additionally, the PE terminal of the first interface module 10 is electrically connected to the PE terminal of the second interface module 30, which are grounded in a charging mode and floating in a discharge mode. The switch module 20 includes a second switch K2 and a third switch K3, where the second switch K2 and the third switch K3 are both relay switches.

The charge and discharge control circuit further includes a drive module 90, where the drive module 90 is electrically connected to the processor 40 and the switch module 20. The processor 40 is configured to control the drive module 90, and the drive module 90 outputs a corresponding control signal to control the on or off state of the switch module 20.

The charge and discharge control circuit further includes a first voltage detection module 91, a second voltage detection module 92, a grounding detection module 93, a temperature detection module 94, a direct current (DC)-DC module 95, a first alternating current (AC)-DC module 96, and a second AC-DC module 98. The first voltage detection module 91 and the grounding detection module 93 are electrically connected to the L1 terminal of the first interface module 10 and the N/L2 terminal of the first interface module 10. The second voltage detection module 92 is electrically connected to the L1 terminal of the second interface module 30 and the N/L2 terminal of the second interface module 30. The temperature detection module 94 is electrically connected to the NTC terminal of the first interface module 10 and the NTC terminal of the second interface module 30. The DC-DC module 95 is electrically connected to the first voltage detection module 91 through the first AC-DC module 96 and electrically connected to the second voltage detection module 92 through the second AC-DC module 98, and the DC-DC module 95 is electrically connected to the processor 40. The first voltage detection module 91 is configured to detect a voltage signal between the L1 terminal of the first interface module 10 and the N/L2 terminal of the first interface module 10. The second voltage detection module 92 is configured to detect a voltage signal of the second interface module 30.

FIG. 6 is a structural diagram of a state switching module according to embodiment three of the present disclosure. Referring to FIGS. 5 and 6, optionally, the charge and discharge control circuit further includes a state switching module 50, the state switching module 50 includes a first identification resistor unit 51 adapted to the charging mode, a second identification resistor unit 52 adapted to the discharge mode, and a first switch K1, and the first switch K1 is configured to control the first identification resistor unit 51 or the second identification resistor unit 52 to be electrically connected to the second interface module 30.

Specifically, the first identification resistor unit 51 or the second identification resistor unit 52 is electrically connected to the CC terminal of the second interface module 30 through the first switch K1. Each identification resistor unit includes two resistors different in resistance. For example, the first identification resistor unit 51 includes two resistors connected in series and having a resistance value of 2.3 K and 1 K, respectively, and the second identification resistor unit 52 includes two resistors connected in series and having a resistance value of 3.3 K and 220 R, respectively. The first switch K1 is a double-pole double-throw relay switch. A second coil terminal of the first switch K1 is connected to a first power supply voltage VDD which may be a 5 V power supply voltage, a first coil terminal of the first switch K1 is electrically connected to a port DRV of the state switching module 50 through a triode and a resistor, and the port DRV of the state switching module 50 is electrically connected to the processor 40. A first terminal of the second identification resistor unit 52 is connected to a first normally closed contact of the first switch K1, and a second terminal of the second identification resistor unit 52 is grounded. A connection terminal between the two resistors connected in series in the second identification resistor unit 52 is connected to a second normally closed contact of the first switch K1. A first terminal of the first identification resistor unit 51 is connected to a first normally open contact of the first switch K1, and a second terminal of the first identification resistor unit 51 is grounded. A connection terminal between the two resistors connected in series in the first identification resistor unit 51 is connected to a second normally open contact of the first switch K1. A first common terminal of the first switch K1 is connected to the CC terminal of the second interface module 30, and a second common terminal of the first switch K1 is connected to the S2 terminal of the second interface module 30. The processor 40 is configured to control a state of the first switch K1 to make the first identification resistor unit 51 or the second identification resistor unit 52 electrically connected to the second interface module 30. If the processor 40 detects that the voltage signal exists between the L1 terminal of the first interface module and the N/L2 terminal of the first interface module and the voltage signal exists between the L1 terminal of the second interface module and the N/L2 terminal of the second interface module, the processor 40 controls the first switch K1 to make the first identification resistor unit 51 connected to the second interface module 30.

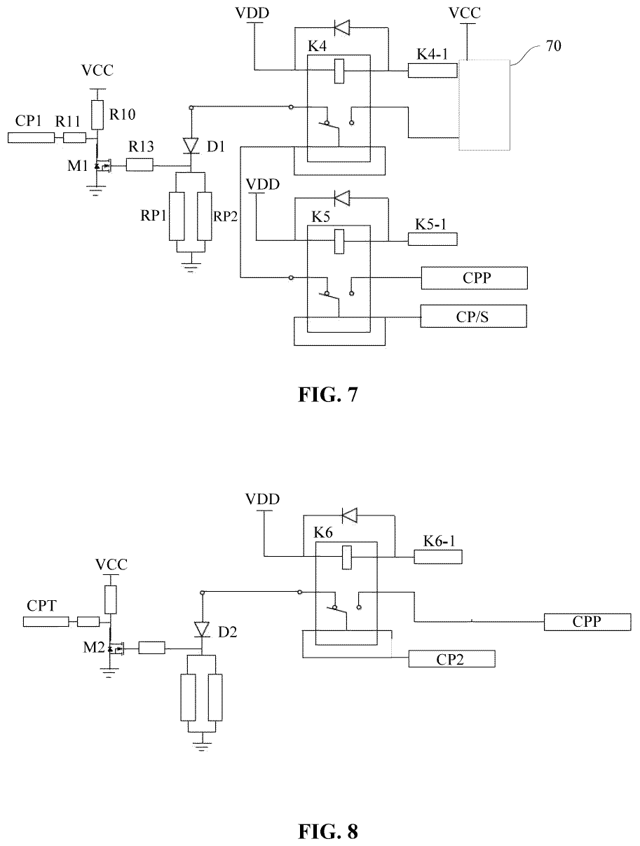

FIG. 7 is a structural diagram of a first signal detection module according to embodiment three of the present disclosure. Referring to FIGS. 5 and 7, optionally, the charge and discharge control circuit further includes a first signal detection module 60, the first signal detection module 60 includes a first field-effect transistor M1, a gate of the first field-effect transistor M1 is configured to receive a voltage signal from the CP/S terminal of the first interface module 10, a drain of the first field-effect transistor M1 is electrically connected to the processor 40 through a first resistor R11, and a source of the first field-effect transistor M1 is grounded.

The gate of the first field-effect transistor M1 receives the voltage signal from the CP/S terminal of the first interface module 10 through a fourth switch K4 and a fifth switch K5, the drain of the first field-effect transistor M1 is electrically connected to a port CP1 of the processor 40 through the first resistor R11, the drain of the first field-effect transistor M1 is connected to a second power supply voltage VCC through a pull-up resistor R10, the second power supply voltage VCC may be a 3.3 V power supply voltage, the gate of the first field-effect transistor M1 is electrically connected to a negative electrode of a first diode D1 through a third resistor R13, a positive electrode of the first diode D1 is electrically connected to the fourth switch K4, and the negative electrode of the first diode D1 is grounded through two resistors connected in parallel. The voltage signal from the signal terminal of the first interface module 10 may be a PWM signal, on and off times of the first field-effect transistor M1 are controlled by a duty cycle of the PWM signal and a frequency of the PWM signal, and the processor 40 determines the duty cycle of the PWM signal and the frequency of the PWM signal according to the on and off of the first field-effect transistor M1. The fourth switch K4 and the fifth switch K5 are each a single-pole double-throw relay switch. A first coil terminal of the fourth switch K4 is connected to the first power supply voltage VDD, a second coil terminal of the fourth switch K4 is electrically connected to a port K4-1 of a driving supplement circuit corresponding to the fourth switch K4, a normally closed contact of the fourth switch K4 is electrically connected to the positive electrode of the first diode D1, the charge and discharge control circuit further includes a type detection module 70, and a normally open contact of the fourth switch K4 is connected to the second power supply voltage VCC through the type detection module 70. A first coil terminal of the fifth switch K5 is connected to the first power supply voltage VDD, a second coil terminal of the fifth switch K5 is electrically connected to a port K5-1 of a driving supplement circuit corresponding to the fifth switch K5, a normally closed contact of the fifth switch K5 is electrically connected to a common terminal of the fourth switch K4, a normally open contact of the fifth switch K5 is electrically connected to a port CPP of a signal generation module, and a common terminal of the fifth switch K5 is electrically connected to the CP/S terminal of the first interface module.

Additionally, the charge and discharge control circuit further includes a second signal detection module 97. FIG. 8 is a structural diagram of a second signal detection module according to embodiment three of the present disclosure. Referring to FIGS. 5 and 8, the second signal detection module 97 includes a second field-effect transistor M2, a gate of the second field-effect transistor M2 is electrically connected to the CP2 terminal of the second interface module through a sixth switch K6, the second field-effect transistor M2 is electrically connected to a port CPT of the processor 40 through one resistor, a drain of the second field-effect transistor M2 is connected to the second power supply voltage VCC through another resistor, the gate of the second field-effect transistor M2 is electrically connected to a negative electrode of a second diode D2 through a resistor, a positive electrode of the second diode D2 is electrically connected to the sixth switch K6, and the negative electrode of the second diode D2 is grounded through two resistors connected in parallel. The sixth switch K6 is a single-pole double-throw relay switch. A first coil terminal of the sixth switch K6 is connected to the first power supply voltage VDD, a second coil terminal of the sixth switch K6 is electrically connected to a port K6-1 of a driving supplement circuit corresponding to the sixth switch K6, a normally closed contact of the sixth switch K6 is electrically connected to the positive electrode of the second diode D2, a normally open contact of the sixth switch K6 is electrically connected to the port CPP of the signal generation module, and a common terminal of the sixth switch K6 is electrically connected to the CP2 terminal of the second interface module. The second signal detection module is configured to detect a second PWM signal at a signal terminal of the second interface module in a vehicle load discharge mode. Presently, the new energy vehicle on the market does not strictly discharge according to a national standard file. Therefore, a magnitude of a discharge current of the vehicle is unknown, and vulnerability exists. The second signal detection module may capture a duty cycle of the second PWM signal so that a limit value of the discharge current of the vehicle can be known.

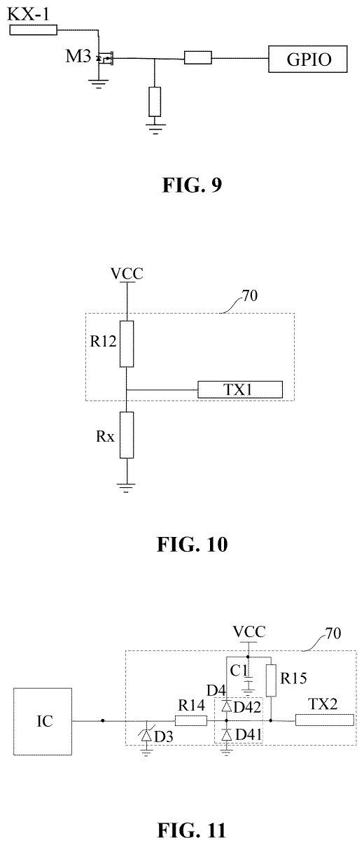

Further, the charge and discharge control circuit further includes the driving supplement circuit. FIG. 9 is a structural diagram of a driving supplement circuit according to an embodiment of the present disclosure. Referring to FIG. 9, the driving supplement circuit includes a third field-effect transistor M3, a gate of the third field-effect transistor M3 is electrically connected to a port GPIO of the processor 40 through a resistor, a drain of the third field-effect transistor M3 is electrically connected to a port KX-1 of the driving supplement circuit, and a source of the third field-effect transistor M3 is grounded, where X in KX-1 may be 4, 5, or 6. In FIGS. 7 and 8, each switch corresponds to its respective driving supplement circuit, and the driving supplement circuit corresponding to each switch has the same structure. That is, in FIGS. 7 and 8, each switch is electrically connected to the port of its corresponding driving supplement circuit through its respective port K4-1, K5-1, or K6-1.

FIG. 10 is a structural diagram of a type detection module according to embodiment three of the present disclosure. Referring to FIGS. 5 and 10, optionally, the charge and discharge control circuit further includes the type detection module 70, the type detection module 70 includes a second resistor R12, the second power supply voltage VCC is input into a first terminal of the second resistor R12, and a second terminal TX1 of the second resistor R12 is electrically connected to the signal terminal of the first interface module 10 through the fourth switch K4 and the fifth switch K5. Specifically, the second terminal TX1 of the second resistor R12 is electrically connected to the normally open contact of the fourth switch K4, and the second terminal TX1 of the second resistor R12 is electrically connected to the processor 40. When the first interface module 10 is connected to the load or the power supply, the first interface module 10 is electrically connected to the load or the power supply through the accessory, the accessory includes at least one of the power plug, the strip, and the accessory charging gun, at least one of the power plug and the strip is provided with a voltage divider identification resistor Rx (including a first voltage divider identification resistor or a second voltage divider identification resistor), and one terminal of the voltage divider identification resistor Rx is electrically connected to the signal terminal of the first interface module 10. When the fourth switch K4 and the fifth switch K5 are turned on, as shown in FIG. 10, it is equivalent to that the voltage divider identification resistor Rx is electrically connected to the second resistor R12. The other terminal of the voltage divider identification resistor Rx is grounded. The processor 40 is configured to acquire an AD value at the signal terminal of the first interface module 10.

For example, the accessory includes the power plug, the power plug includes a 10 A plug, a 16 A plug, or a 32 A industrial plug, and second voltage divider identification resistors with different resistance values are disposed in different plugs. When the second resistor R12 is electrically connected to voltage divider identification resistors Rx with different resistance values, the second resistor R12 has different voltages so that the processor 40 identifies a type of the power plug according to different AD values.

When the first interface module 10 is connected to the load, a non-vehicle load is electrically connected to the first interface module 10 through the strip, and a vehicle load is electrically connected to the first interface module 10 through the accessory charging gun, where the strip includes the first voltage divider identification resistor. The first voltage divider identification resistor and the second voltage divider identification resistor have different resistance values. The first voltage divider identification resistor is connected to the first interface module 10 in the same manner as the second voltage divider identification resistor, that is, different voltage divider identification resistors Rx are disposed so that whether the connected load is the vehicle load or the non-vehicle load can be determined.

As another solution of this embodiment, at least one of the power plug and the strip is provided with a temperature sensing IC, and the type detection module identifies the type of the power plug and a type of the strip according to digital information from the temperature sensing IC, where the digital information is a digital high or low level and includes information such as a serial number and a production date of the product.

FIG. 11 is a structural diagram of another type detection module according to embodiment three of the present disclosure. Referring to FIGS. 5 and 11, optionally, the type detection module 70 includes a Zener diode D3, a clamping diode D4, a fourth resistor R14, and a filtering capacitor C1; a positive electrode of the Zener diode D3 is grounded, and a negative electrode of the Zener diode D3 is electrically connected to the signal terminal of the first interface module 10 through the fourth switch K4 and the fifth switch K5; specifically, the negative electrode of the Zener diode D3 is electrically connected to the normally open contact of the fourth switch K4; the negative electrode of the Zener diode D3 is electrically connected to a first terminal TX2 of the clamping diode D4 through the fourth resistor R14, the first terminal TX2 of the clamping diode D4 is electrically connected to the processor 40, a second terminal of the clamping diode D4 is grounded, the second power supply voltage VCC is input into a third terminal of the clamping diode D4, the third terminal of the clamping diode D4 is grounded through the filtering capacitor C1, and the third terminal of the clamping diode D4 is electrically connected to the first terminal of the clamping diode D4 through a fifth resistor R15.

The Zener diode D3 is configured for stabilizing voltage to prevent the temperature sensing IC from being burnt due to an extremely large voltage. The clamping diode D4 is a double-diode structure and includes a third diode D41 and a fourth diode D42, a negative electrode of the third diode D41 serves as the first terminal of the clamping diode D4, a positive electrode of the third diode D41 serves as the second terminal of the clamping diode D4, the negative electrode of the third diode D41 is electrically connected to a positive electrode of the fourth diode D42, and a negative electrode of the fourth diode D42 serves as the third terminal of the clamping diode D4. The clamping diode D4 is configured to prevent the processor 40 from being damaged due to an extremely high or low voltage. The fourth resistor R14 is configured to prevent an excessively large current from flowing into the temperature sensing IC. The filtering capacitor C1 is configured to filter high-frequency interference and noise of the second power supply voltage VCC. Specifically, when the first interface module 10 is connected to the load or the power supply, the first interface module 10 is electrically connected to the load or the power supply through the accessory, the accessory is provided with the temperature sensing IC, and the temperature sensing IC is electrically connected to the signal terminal of the first interface module 10. When the fourth switch K4 and the fifth switch K5 are turned on, as shown in FIG. 10, it is equivalent to that the temperature sensing IC is electrically connected to the negative electrode of the Zener diode D3. The processor 40 is configured to acquire the digital information at the signal terminal of the first interface module 10. For example, the accessory includes the power plug, the power plug includes the 10 A plug, the 16 A plug, or the 32 A industrial plug, and temperature sensing ICs in different plugs transmit different digital information so that the processor 40 identifies the type of the power plug according to different digital information.

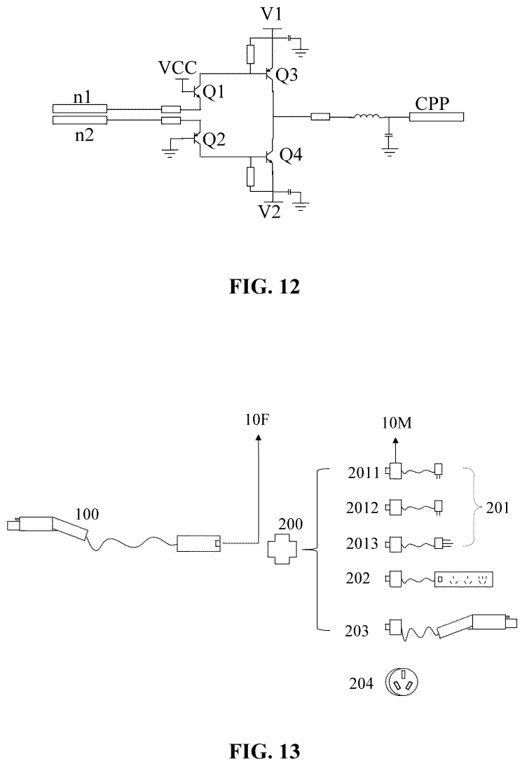

FIG. 12 is a structural diagram of a signal generation module according to embodiment three of the present disclosure. Referring to FIGS. 5 and 12, optionally, the charge and discharge control circuit further includes a signal generation module 80, the signal generation module 80 includes a first triode Q1, a second triode Q2, a third triode Q3, and a fourth triode Q4, the second power supply voltage VCC is input into a base of the first triode Q1, a collector of the first triode Q1 is electrically connected to a base of the third triode Q3, an emitter of the first triode Q1 and an emitter of the second triode Q2 are connected to different ports of the processor 40, a base of the second triode Q2 is grounded, a collector of the second triode Q2 is electrically connected to a base of the fourth triode Q4, a first voltage V1 is input into an emitter of the third triode Q3, a collector of the fourth triode Q4 and a collector of the third triode Q3 are both electrically connected to the first interface module 10, and a second voltage V2 is input into an emitter of the fourth triode Q4.

Specifically, the collector of the fourth triode Q4 and the collector of the third triode Q3 are both electrically connected to the port CPP of the signal generation module 80 through a resistor and an inductor that are connected in series. The emitter of the first triode Q1 and the emitter of the second triode Q2 are connected to two channels n1 and n2 of the same timer of the processor 40 respectively through different resistors and may be configured to be in a complementary mode or a synchronous mode. Synchronous square wave signals are generated by the timer of the processor 40 and pass through the first triode Q1, the second triode Q2, the third triode Q3, and the fourth triode Q4 so that a square wave signal of a high level such as the first voltage V1 of +12 V and a square wave signal of a low level such as the second voltage V2 of-2 V can be generated according to the superposition theorem.

FIG. 13 is a partial structural diagram of an integrated charging and discharging gun according to embodiment three of the present disclosure. Referring to FIG. 13, the integrated charging and discharging gun includes a vehicle-end charging and discharging gun body 100 and an accessory 200, where the vehicle-end charging and discharging gun body 100 includes the charge and discharge control circuit according to any embodiment of the present disclosure; and the accessory 200 is adapted to the first interface module 10, and the accessory 200 includes at least one of a power plug 201, a strip 202, and an accessory charging gun 203. Specifically, the second interface module 30 is disposed at an end of the vehicle-end charging and discharging gun body 100 connected to the vehicle, and the first interface module 10 is disposed at an end of the vehicle-end charging and discharging gun body 100 connected to the accessory 200; and the accessory mates with the first interface module 10 through the male terminal and the female terminal. The first interface module 10 includes a first interface module male-terminal 10M and a first interface module female-terminal 10F, the power plug 201 includes three types of power plugs, such as a 10 A plug 2011, a 16 A plug 2012, and a 32 A industrial plug 2013, and the accessory further includes a 16 A to 10 A adapter 204.

The charge and discharge control circuit and the integrated charging and discharging gun of this embodiment and the charge and discharge control method of any embodiment of the present disclosure belong to the same inventive concept and have the corresponding beneficial effects. For technical details not described in detail in this embodiment, see the charge and discharge control method of any embodiment of the present disclosure.

It is to be noted that preferred embodiments of the present disclosure and technical principles used therein are described above. It is to be understood by those skilled in the art that the present disclosure is not limited to the embodiments described herein. Those skilled in the art can make various apparent modifications, adaptations, combinations, and substitutions without departing from the scope of the present disclosure. Therefore, although the present disclosure has been described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A charge and discharge control method, performed by a processor in a charge and discharge control circuit, wherein the charge and discharge control circuit comprises a first interface module, a switch module, a second interface module, and the processor;
an L1 terminal of the first interface module is connected to an L1 terminal of the second interface module through the switch module; an N/L2 terminal of the first interface module is connected to an N/L2 terminal of the second interface module through the switch module; and
the switch module is configured to control the L1 terminal of the first interface module and the N/L2 terminal of the first interface module to be connected to or disconnected from the L1 terminal of the second interface module and the N/L2 terminal of the second interface module, respectively; and
the second interface module is configured to be electrically connected to a vehicle, the first interface module, the switch module, and the second interface module are all electrically connected to the processor, and the first interface module is configured to be connected to a load or a power supply; and
wherein the charge and discharge control method comprises:
detecting a voltage signal between the L1 terminal of the first interface module and the N/L2 terminal of the first interface module and a voltage signal between the L1 terminal of the second interface module and the N/L2 terminal of the second interface module;
in response to existence of the voltage signal between the L1 terminal of the first interface module and the N/L2 terminal of the first interface module and absence of the voltage signal between the L1 terminal of the second interface module and the N/L2 terminal of the second interface module, controlling the vehicle to enter a charging mode; and
in response to absence of the voltage signal between the L1 terminal of the first interface module and the N/L2 terminal of the first interface module and existence of the voltage signal between the L1 terminal of the second interface module and the N/L2 terminal of the second interface module, controlling the vehicle to enter a discharge mode.

2. The charge and discharge control method of claim 1, wherein the charge and discharge control circuit further comprises a state switching module, the state switching module comprises a first identification resistor unit adapted to the charging mode, a second identification resistor unit adapted to the discharge mode, and a first switch, and the first switch is configured to control the first identification resistor unit or the second identification resistor unit to be electrically connected to the second interface module; and
controlling the vehicle to enter the charging mode comprises:
in response to the existence of the voltage signal between the L1 terminal of the first interface module and the N/L2 terminal of the first interface module and the existence of the voltage signal between the L1 terminal of the second interface module and the N/L2 terminal of the second interface module, controlling a state of the first switch such that the first identification resistor unit is connected to the second interface module;
re-detecting the voltage signal between the L1 terminal of the first interface module and the N/L2 terminal of the first interface module and the voltage signal between the L1 terminal of the second interface module and the N/L2 terminal of the second interface module; and
in response to the existence of the voltage signal between the L1 terminal of the first interface module and the N/L2 terminal of the first interface module and the absence of the voltage signal between the L1 terminal of the second interface module and the N/L2 terminal of the second interface module, controlling the vehicle to enter the charging mode.

3. The charge and discharge control method of claim 2, before detecting the voltage signal between the L1 terminal of the first interface module and the N/L2 terminal of the first interface module and the voltage signal between the L1 terminal of the second interface module and the N/L2 terminal of the second interface module, comprising:
setting an initial state, wherein the initial state comprises that the L1 terminal of the first interface module and the N/L2 terminal of the first interface module are disconnected from the L1 terminal of the second interface module and the N/L2 terminal of the second interface module and that the second identification resistor unit is connected to the second interface module.

4. The charge and discharge control method of claim 1, wherein the load comprises a vehicle load and a non-vehicle load, the non-vehicle load is electrically connected to the first interface module through a strip, and the vehicle load is electrically connected to the first interface module through an accessory charging gun, wherein the strip comprises a first voltage divider identification resistor;
the charge and discharge control circuit further comprises a type detection module configured to output an analog-to-digital (AD) value according to the first voltage divider identification resistor; and
wherein controlling the vehicle to enter the discharge mode comprises:
acquiring the AD value output from the type detection module, and determining, according to the AD value, whether the first interface module is connected to the vehicle load or the non-vehicle load;
in response to the first interface module being connected to the vehicle load, controlling the vehicle to enter a vehicle load discharge mode;
in response to the first interface module being connected to the non-vehicle load, controlling the vehicle to enter a non-vehicle load discharge mode; and
controlling the L1 terminal of the first interface module and the N/L2 terminal of the first interface module to be connected to the L1 terminal of the second interface module and the N/L2 terminal of the second interface module, respectively.

5. The charge and discharge control method of claim 1, wherein the load comprises a vehicle load and a non-vehicle load, the non-vehicle load is electrically connected to the first interface module through a strip, and the vehicle load is electrically connected to the first interface module through an accessory charging gun, wherein the strip comprises a temperature sensing integrated circuit (IC);
the charge and discharge control circuit further comprises a type detection module configured to acquire digital information output from the temperature sensing IC; and
wherein controlling the vehicle to enter the discharge mode comprises:
acquiring the digital information output from the temperature sensing IC, and determining, according to the digital information, whether the first interface module is connected to the vehicle load or the non-vehicle load;
in response to the first interface module being connected to the vehicle load, controlling the vehicle to enter a vehicle load discharge mode;
in response to the first interface module being connected to the non-vehicle load, controlling the vehicle to enter a non-vehicle load discharge mode; and
controlling the L1 terminal of the first interface module and the N/L2 terminal of the first interface module to be connected to the L1 terminal of the second interface module and the N/L2 terminal of the second interface module, respectively.

6. The charge and discharge control method of claim 4, wherein controlling the vehicle to enter the vehicle load discharge mode comprises:
detecting whether a second pulse-width modulation (PWM) signal exists at a signal terminal of the second interface module; and
in response to the second PWM signal at the signal terminal of the second interface module, outputting a second target PWM signal to the vehicle load according to the second PWM signal.

7. The charge and discharge control method of claim 1, wherein
the power supply comprises a charging pile or a power grid; and
wherein controlling the vehicle to enter the charging mode comprises:
detecting whether a first PWM signal exists at a signal terminal of the first interface module;
in response to the first PWM signal at the signal terminal of the first interface module, controlling the vehicle to enter a charging pile charging mode; and
in response to no first PWM signal at the signal terminal of the first interface module, controlling the vehicle to enter a power grid charging mode.

8. The charge and discharge control method of claim 7, wherein
the charge and discharge control circuit further comprises a first signal detection module, the first signal detection module comprises a first field-effect transistor, a gate of the first field-effect transistor is configured to receive a voltage signal from the signal terminal of the first interface module, a drain of the first field-effect transistor is electrically connected to the processor through a first resistor, a power supply voltage is input into the drain of the first field-effect transistor through a pull-up resistor, and a source of the first field-effect transistor is grounded; and
wherein controlling the vehicle to enter the charging pile charging mode comprises:
acquiring a duty cycle of the first PWM signal and a frequency of the first PWM signal through the first signal detection module; and
outputting a first target PWM signal to the vehicle according to the duty cycle of the first PWM signal and the frequency of the first PWM signal.

9. The charge and discharge control method of claim 7, wherein the first interface module is configured to be connected to the power grid through a power plug; and
wherein controlling the vehicle to enter the power grid charging mode comprises:
identifying a type of the power plug and detecting a capacity of the power plug; and
outputting a third target PWM signal to the vehicle according to the capacity of the power plug.

10. A charge and discharge control circuit, comprising: a first interface module, a switch module, a second interface module, and a processor; wherein an L1 terminal of the first interface module is connected to an L1 terminal of the second interface module through the switch module; an N/L2 terminal of the first interface module is connected to an N/L2 terminal of the second interface module through the switch module; the switch module is configured to control the L1 terminal of the first interface module and the N/L2 terminal of the first interface module to be connected to or disconnected from the L1 terminal of the second interface module and the N/L2 terminal of the second interface module, respectively; and the second interface module is configured to be electrically connected to a vehicle, the first interface module, the switch module, and the second interface module are all electrically connected to the processor, and the first interface module is configured to be connected to a load or a power supply.

11. The charge and discharge control circuit of claim 10, further comprising a state switching module, wherein the state switching module comprises a first identification resistor unit adapted to a charging mode, a second identification resistor unit adapted to a discharge mode, and a first switch, and the first switch is configured to control the first identification resistor unit or the second identification resistor unit to be electrically connected to the second interface module.

12. The charge and discharge control circuit of claim 10, further comprising a first signal detection module, wherein the first signal detection module comprises a first field-effect transistor, a gate of the first field-effect transistor is configured to receive a voltage signal from a signal terminal of the first interface module, a drain of the first field-effect transistor is electrically connected to the processor through a first resistor, a power supply voltage is input into the drain of the first field-effect transistor through a pull-up resistor, and a source of the first field-effect transistor is grounded.

13. The charge and discharge control circuit of claim 10, further comprising a type detection module, wherein the type detection module comprises a second resistor, and when the type detection module is in operation, a power supply voltage is input into one terminal of the second resistor, and another terminal of the second resistor is electrically connected to a signal terminal of the first interface module;
when the first interface module is connected to the load or the power supply, the first interface module is electrically connected to the load or the power supply through an accessory, the accessory comprises at least one of a power plug, a strip, and an accessory charging gun, at least one of the power plug and the strip is provided with a voltage divider identification resistor, one terminal of the voltage divider identification resistor is electrically connected to the signal terminal of the first interface module, and another terminal of the voltage divider identification resistor is grounded; and
the processor is configured to acquire an analog-to-digital (AD) value at the signal terminal of the first interface module.

14. The charge and discharge control circuit of claim 10, further comprising a type detection module, wherein the type detection module comprises a Zener diode, a clamping diode, a fourth resistor, and a filtering capacitor, a positive electrode of the Zener diode is grounded, a negative electrode of the Zener diode is electrically connected to a signal terminal of the first interface module, the negative electrode of the Zener diode is electrically connected to a first terminal of the clamping diode through the fourth resistor, a second terminal of the clamping diode is grounded, a power supply voltage is input into a third terminal of the clamping diode, the third terminal of the clamping diode is grounded through the filtering capacitor, and the third terminal of the clamping diode is electrically connected to the first terminal of the clamping diode through a fifth resistor;
when the first interface module is connected to the load or the power supply, the first interface module is electrically connected to the load or the power supply through an accessory, the accessory comprises at least one of a power plug, a strip, and an accessory charging gun, at least one of the power plug and the strip is provided with a temperature sensing integrated circuit (IC), and the temperature sensing IC is electrically connected to the signal terminal of the first interface module; and
the processor is configured to acquire digital information at the signal terminal of the first interface module.

15. The charge and discharge control circuit of claim 10, further comprising a signal generation module, wherein the signal generation module comprises a first triode, a second triode, a third triode, and a fourth triode, a power supply voltage is input into a base of the first triode, a collector of the first triode is electrically connected to a base of the third triode, an emitter of the first triode and an emitter of the second triode are connected to different ports of the processor, a base of the second triode is grounded, a collector of the second triode is electrically connected to a base of the fourth triode, a second voltage is input into an emitter of the fourth triode, a collector of the fourth triode is electrically connected to a collector of the third triode, the collector of the fourth triode is electrically connected to a signal terminal of the first interface module or a control pilot terminal of the second interface module when the signal generation module is in operation, and a first voltage is input into an emitter of the third triode.

16. An integrated charging and discharging gun, comprising: a vehicle-end charging and discharging gun body and an accessory, wherein the vehicle-end charging and discharging gun body comprises a charge and discharge control circuit comprising a first interface module, a switch module, a second interface module, and a processor,
wherein an L1 terminal of the first interface module is connected to an L1 terminal of the second interface module through the switch module; an N/L2 terminal of the first interface module is connected to an N/L2 terminal of the second interface module through the switch module; the switch module is configured to control the L1 terminal of the first interface module and the N/L2 terminal of the first interface module to be connected to or disconnected from the L1 terminal of the second interface module and the N/L2 terminal of the second interface module, respectively; and the second interface module is configured to be electrically connected to a vehicle, the first interface module, the switch module, and the second interface module are all electrically connected to the processor, and the first interface module is configured to be connected to a load or a power supply; and
the accessory is adapted to the first interface module, and the accessory comprises at least one of a power plug, a strip, and an accessory charging gun.

17. The integrated charging and discharging gun of claim 16, further comprising a state switching module, wherein the state switching module comprises a first identification resistor unit adapted to a charging mode, a second identification resistor unit adapted to a discharge mode, and a first switch, and the first switch is configured to control the first identification resistor unit or the second identification resistor unit to be electrically connected to the second interface module.

18. The integrated charging and discharging gun of claim 16, further comprising a first signal detection module, wherein the first signal detection module comprises a first field-effect transistor, a gate of the first field-effect transistor is configured to receive a voltage signal from a signal terminal of the first interface module, a drain of the first field-effect transistor is electrically connected to the processor through a first resistor, a power supply voltage is input into the drain of the first field-effect transistor through a pull-up resistor, and a source of the first field-effect transistor is grounded.

19. The integrated charging and discharging gun of claim 16, further comprising a type detection module, wherein the type detection module comprises a second resistor, and when the type detection module is in operation, a power supply voltage is input into one terminal of the second resistor, and another terminal of the second resistor is electrically connected to a signal terminal of the first interface module;
when the first interface module is connected to the load or the power supply, the first interface module is electrically connected to the load or the power supply through an accessory, the accessory comprises at least one of a power plug, a strip, and an accessory charging gun, at least one of the power plug and the strip is provided with a voltage divider identification resistor, one terminal of the voltage divider identification resistor is electrically connected to the signal terminal of the first interface module, and another terminal of the voltage divider identification resistor is grounded; and
the processor is configured to acquire an analog-to-digital (AD) value at the signal terminal of the first interface module.

20. The integrated charging and discharging gun of claim 16, further comprising a type detection module, wherein the type detection module comprises a Zener diode, a clamping diode, a fourth resistor, and a filtering capacitor, a positive electrode of the Zener diode is grounded, a negative electrode of the Zener diode is electrically connected to a signal terminal of the first interface module, the negative electrode of the Zener diode is electrically connected to a first terminal of the clamping diode through the fourth resistor, a second terminal of the clamping diode is grounded, a power supply voltage is input into a third terminal of the clamping diode, the third terminal of the clamping diode is grounded through the filtering capacitor, and the third terminal of the clamping diode is electrically connected to the first terminal of the clamping diode through a fifth resistor;
when the first interface module is connected to the load or the power supply, the first interface module is electrically connected to the load or the power supply through an accessory, the accessory comprises at least one of a power plug, a strip, and an accessory charging gun, at least one of the power plug and the strip is provided with a temperature sensing integrated circuit (IC), and the temperature sensing IC is electrically connected to the signal terminal of the first interface module; and
the processor is configured to acquire digital information at the signal terminal of the first interface module.
